(19) United States
(12) Patent Application Publication
(10) Pub. No.: US 2019/0143607 A1
(43) Pub. Date: May 16, 2019

(54) THERMAL DEFORMATION AMOUNT CALCULATION DEVICE, THREE-DIMENSIONAL LAMINATION SYSTEM, THREE-DIMENSIONAL LAMINATION METHOD, AND PROGRAM

(71) Applicant: MITSUBISHI HEAVY INDUSTRIES, LTD., Tokyo (JP)

(72) Inventors: Naoki OGAWA, Tokyo (JP); Keisuke KAMITANI, Tokyo (JP)

(21) Appl. No.: 16/307,536

(22) PCT Filed: Dec. 22, 2017
(86) PCT No.: PCT/JP2017/046113

§ 371 Date: Dec. 6, 2018

(30) Foreign Application Priority Data
Dec. 26, 2016 (JP) 2016-251138

(51) Int. Cl. B29C 64/393; G01N 25/16; B33Y 50/02

(52) U.S. Cl. CPC B29C 64/393; B33Y 50/02; G01N 25/16

(57) ABSTRACT

A thermal deformation amount calculation device analyzes thermal deformation occurring in a product when the product is manufactured by sequentially laminating materials and performing heat input using a three-dimensional lamination device. The thermal deformation amount calculation device includes a heat input pattern reception unit, a constraint condition extraction unit, an inherent strain determination unit, and a thermal deformation amount determination unit.

### TECHNICAL FIELD

The present invention relates to a thermal deformation amount calculation device, a three-dimensional lamination system, a three-dimensional lamination method, and a program.

Priority is claimed on Japanese Patent Application No. 2016-251138, filed Dec. 26, 2016, the content of which is incorporated herein by reference.

### BACKGROUND ART

A three-dimensional lamination product (hereinafter referred to as a “product”) which is shaped through lamination in a three-dimensional lamination device (a so-called 3D printer) is expected to be able to realize complex and precise part shapes.

### CITATION LIST

### Patent Literature

[Patent Document 1]

Japanese Unexamined Patent Application, First Publication No. 2005-330141

### SUMMARY OF INVENTION

### Technical Problem

When a product is laminated and, particularly, when a product having a complicated shape is laminated, a support portion supporting the product is also simultaneously laminated in parallel so that the shape is manufactured as intended. However, when rigidity of the support portion is not sufficient, warpage occurs during the lamination, the next lamination cannot be performed, and an intended shape cannot be obtained. This is because thermal deformation (heat shrinkage) occurs due to heat conduction at the time of the lamination, and as a result, a difference in shape from a designed shape occurs.

Therefore, setting the position, the shape, or the like of the support portion personally, making a prototype of the product, and confirming the presence or absence of thermal deformation are repeated in a current situation, and it takes much time to set the support portion capable of reducing the thermal deformation. On the other hand, since the support portion is removed after the lamination, uniformly high rigidity may not be good. That is, the support portion suppresses the thermal deformation, but rigidity allowing easy removal after the lamination is desirable.

Therefore, thermal deformation is suppressed, but it is necessary to accurately predict a structure of the support portion that realizes rigidity allowing easy removal after the lamination. Modeling a powder constituting a product or a support portion that is indurated due to heat input and simulating a structure of the support portion using the model is conceivable as a method of accurately performing the prediction. However, it takes much time to simulate a large number of powders. Further, simulating a structure of a product or support portion using an inherent strain when the powder is indurated is conceivable as another method of accurately performing the prediction. However, an inherent strain of a material in which the powder constituting the support portion has been indurated is determined to be one value depending on physical properties. Therefore, even when a support portion has a different structure, simulation of the structure of the support portion is performed using the same inherent strain, and thus the structure of the support portion cannot be accurately specified.

An object of the present invention is to provide a thermal deformation amount calculation device, a three-dimensional lamination system, a three-dimensional lamination method, and a program capable of solving the above problems.

### Solution to Problem

According to one aspect of the present invention, a thermal deformation amount calculation device is a thermal deformation amount calculation device for analyzing thermal deformation occurring in a product when the product is manufactured by sequentially laminating materials and performing heat input using a three-dimensional lamination device, wherein one layer is configured of a plurality of heat input portions which are units in which input heat is received from the three-dimensional lamination device, and the thermal deformation amount calculation device includes: a heat input pattern reception unit that is configured to receive a heat input pattern that is an order in which the plurality of heat input portions receive the input heat; a constraint condition extraction unit that is configured to extract a constraint condition in each of the plurality of heat input portions on the basis of the heat input pattern; an inherent strain determination unit that is configured to obtain an inherent strain in each of the plurality of heat input portions on the basis of the constraint condition; and a thermal deformation amount determination unit that is configured to obtain thermal deformation of the product on the basis of the inherent strain in each of the plurality of heat input portions.

### Advantageous Effects of Invention

With the thermal deformation amount calculation device according to the embodiments of the present invention, it is possible to accurately evaluate the thermal deformation amount of the laminated structure in a short time.

### BRIEF DESCRIPTION OF DRAWINGS

FIG. 1 is a diagram showing a configuration of a three-dimensional lamination system according to a first embodiment of the present invention.

FIG. 2 is a diagram showing a configuration of a three-dimensional lamination thermal deformation amount calculation device according to the first embodiment of the present invention.

FIG. 3 is a diagram for explaining a heat input pattern in the first embodiment of the present invention.

FIG. 4 is a block diagram showing a configuration of an information processing device that realizes the three-dimensional lamination thermal deformation amount calculation device according to the first embodiment of the present invention.

FIG. 5 is a diagram showing a process flow of the three-dimensional lamination thermal deformation amount calculation device according to the first embodiment of the present invention.

FIG. 6 is a diagram showing an example of a constraint condition in the first embodiment of the present invention.

FIG. 7 is a diagram showing an example of a constraint condition in a second embodiment of the present invention.

FIG. 8 is a diagram showing an example of a constraint condition in a third embodiment of the present invention.

FIG. 9 is a diagram showing a configuration of a three-dimensional lamination thermal deformation amount calculation device according to a fourth embodiment of the present invention.

FIG. 10 is a diagram showing a change in shaping data using the three-dimensional lamination thermal deformation amount calculation device according to the fourth embodiment of the present invention.

FIG. 11 is a diagram showing a process flow of the three-dimensional lamination thermal deformation amount calculation device according to the fourth embodiment of the present invention.

### DESCRIPTION OF EMBODIMENTS

### First Embodiment

Hereinafter, a configuration of a three-dimensional lamination system including a three-dimensional lamination thermal deformation amount calculation device according to a first embodiment of the present invention will be described.

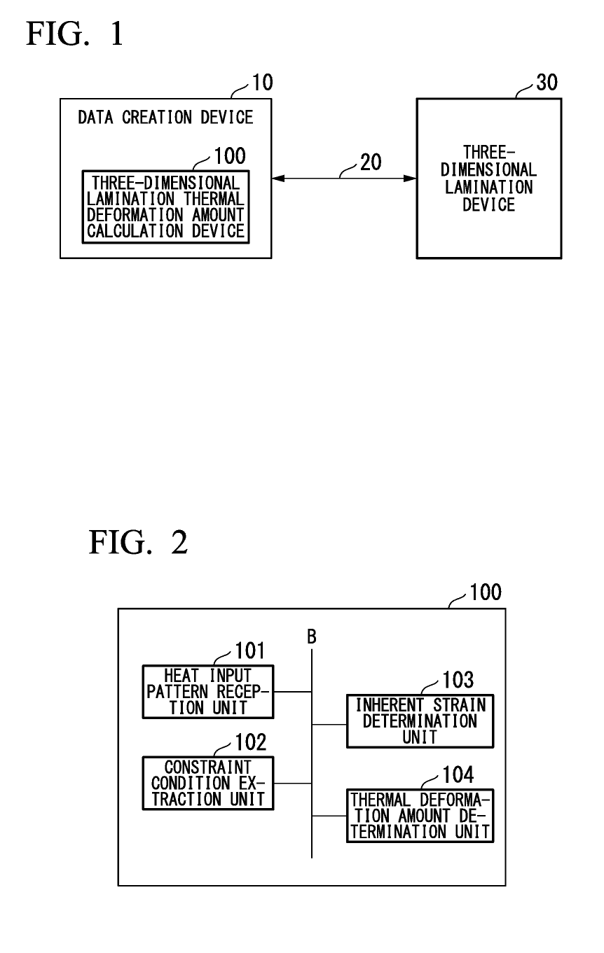

As shown in FIG. 1, the three-dimensional lamination system 1 includes a data creation device 10, a network 20, and a three-dimensional lamination device 30.

For example, the three-dimensional lamination device 30 is a device using a “powder bed fusion method,” in which a thinly laminated powder is sintered or melted with a laser (or an electron beam) and solidified, and the sintered or melted and solidified material is laminated to shape a product having a three-dimensional shape. It should be noted that examples of the three-dimensional lamination device 30 include various types of devices. Examples of the three-dimensional lamination device 30 may include a device using a method of sintering or inciting and solidifying a material, and a device using a “directed energy deposition method.”

The network 20 is Ethernet (registered trademark) or the like. The network 20 may be a wired or wireless network. Further, the network 20 may be a network such as the Internet. In such a case, even when the three-dimensional lamination device 30 is at a place remote from the data creation device 10, the data creation device 10 and the three-dimensional lamination device 30 can communicate via the network 20. It should be noted that when the data creation device 10 and the three-dimensional lamination device 30 can be disposed close to each other, the data creation device 10 and the three-dimensional lamination device 30 may be directly connected without using the network 20.

The data creation device 10 is a device that creates shaping data that is used when the three-dimensional lamination device 30 shapes a product having a three-dimensional shape, and provides instructions on a manipulation with respect to the three-dimensional lamination device 30.

Specifically, the data creation device 10 reads product shaping data indicating the three-dimensional shape of the product. The data creation device 10 determines a posture of the product in which the amount of materials that are used in the support portion that supports the product is minimized. The data creation device 10 derives the inherent strain using thermal-elastic-plastic analysis. The data creation device 10 performs support dimension optimization analysis for optimizing dimensions of the support portion using the derived inherent strain as a boundary condition. The data creation device 10 converts dimensions of each layer of the product into shaping data. The data creation device 10 sets construction conditions of the product. The data creation device 10 causes the three-dimensional lamination device 30 to manufacture the product.

The three-dimensional lamination thermal deformation amount calculation device 100 according to the first embodiment of the present invention is included in the data creation device 10. The three-dimensional lamination thermal deformation amount calculation device 100 is a device that performs a process of deriving an inherent strain using thermal-elastic-plastic analysis among the processes that are performed by the data creation device 10 described above.

The three-dimensional lamination thermal deformation amount calculation device 100 according to the first embodiment of the present invention sequentially laminates materials using the three-dimensional lamination device, and performs heat input to analyze thermal deformation that will occur in the product when the product is manufactured (performs thermo-elastic-plastic analysis) and derive inherent strain.

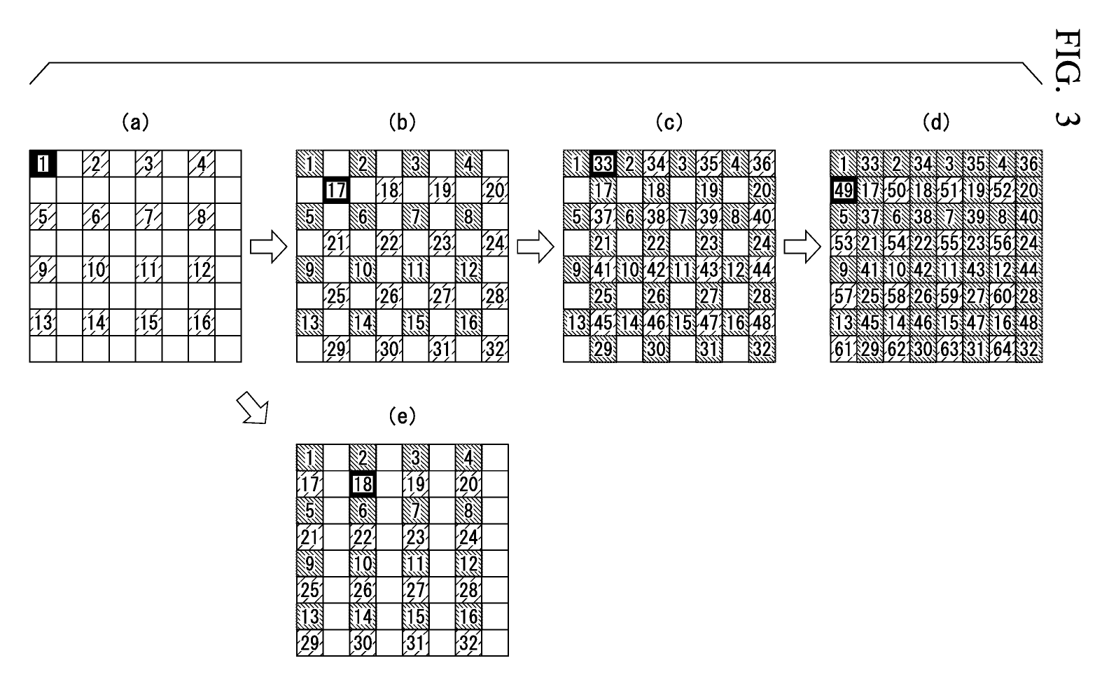

As shown in FIG. 2, the three-dimensional lamination thermal deformation amount calculation device 100 includes a heat input pattern reception unit 101, a constraint condition extraction unit 102, an inherent strain determination unit 103, and a thermal deformation amount determination unit 104.

The heat input pattern reception unit 101 receives a heat input pattern configured of a plurality of heat input portions in one of layers laminated by the three-dimensional lamination device. The heat input portion is a region in which heat is applied to powders when the three-dimensional lamination device performs the lamination. The heat input pattern indicates, for example, an order in which heat is input to the heat input portions, such as an order of receiving input heat.

The constraint condition extraction unit 102 extracts the constraint condition in each of the plurality of heat input portions on the basis of the heat input pattern received by the heat input pattern reception unit 101. Here, the constraint condition is a condition that is determined according to a heat input situation of heat input portions located near a heat input portion.

The inherent strain determination unit 103 obtains the inherent strain in each of the plurality of heat input portions on the basis of the constraint condition extracted by the constraint condition extraction unit 102.

The thermal deformation amount determination unit 104 obtains a thermal deformation of the product on the basis of the inherent strain in each of the plurality of heat input portions obtained by the inherent strain determination unit 103.

Here, the heat input pattern will be described.

The heat input pattern indicates an order in which heat is applied to a region indicated by each of squares obtained by dividing a cross section in one layer into, for example, intersections on a Go board every 5 mm. Here, each region is a heat input portion. Powders in the region to which heat has been applied are combined with each other to form a layer of product in a cross section thereof. The heat input pattern for the divided regions is determined, for example, as shown in parts (a) to (d) of FIG. 3. Specifically, when the cross section is represented by a region of 8×8, first, an order of applying heat to 16 regions 1 to 16 is determined, as shown in part (a) of FIG. 3. The order of applying heat to the 16 regions 1 to 16 is randomly determined using a random number or the like. The order of applying heat to 16 regions 17 to 32 is then determined, as shown in part (b) of FIG. 3. The order of applying heat to the 16 regions 17 to 32 is randomly determined. An order of applying heat to 16 regions 33 to 48 is then determined, as shown in part (c) of FIG. 3. The order of applying heat to the 16 regions 33 to 48 is randomly determined. Finally, the order of applying heat to 16 regions 49 to 64 is determined, as shown in part (d) of FIG. 3. The order of applying heat to the 16 regions 49 to 64 is randomly determined.

It should be noted that the heat input pattern for the divided regions is influenced by the presence or absence of constraints from the surroundings. For example, in each of the 32 regions shown in parts (a) and (b) of FIG. 3, there are no adjacent regions in which heat has already been applied when the heat is applied to the 32 regions. Therefore, in each of the 32 regions shown in parts (a) and (b) of FIG. 3, the influence of constraints from the surroundings when the heat is applied is often small.

Further, for example, in the region indicated by 33 shown in part (c) of FIG. 3, there are three adjacent regions to which heat has already been applied when the heat is applied to the region indicated by 33. Therefore, in the region indicated by 33, an influence of constraints from the surroundings when the heat is applied is often larger than that in each of the 32 regions shown in parts (a) and (b) of FIG. 3. Further, for example, in the region indicated by 50 shown in part (d) of FIG. 3, there are four adjacent regions to which heat has already been applied when the heat is applied to the region indicated by 50. Therefore, in the region indicated by 50, an influence of constraints from the surroundings when the heat is applied is often larger than that in the region indicated by 33.

Further, when the heat is applied to 16 regions including 17 to 32 next to the 16 regions including 1 to 16 as shown in part (e) of FIG. 3, for example, in the region indicated by 18, there are two adjacent regions to which heat has already been applied when the heat is applied to the region indicated by 18. Therefore, in the region indicated by 18 shown in part (e) of FIG. 3, an influence of constraints from the surroundings when the heat between each of the 32 regions shown in parts (a) and (b) of FIG. 3 and the region indicated by 33 shown in part (c) of FIG. 3 is applied is often larger.

However, the heat input pattern for the divided regions is not limited to that shown in FIG. 3 described above. For example, in the heat input pattern for the divided regions, an order of applying heat to each region in all targets to which heat is applied may be randomly determined.

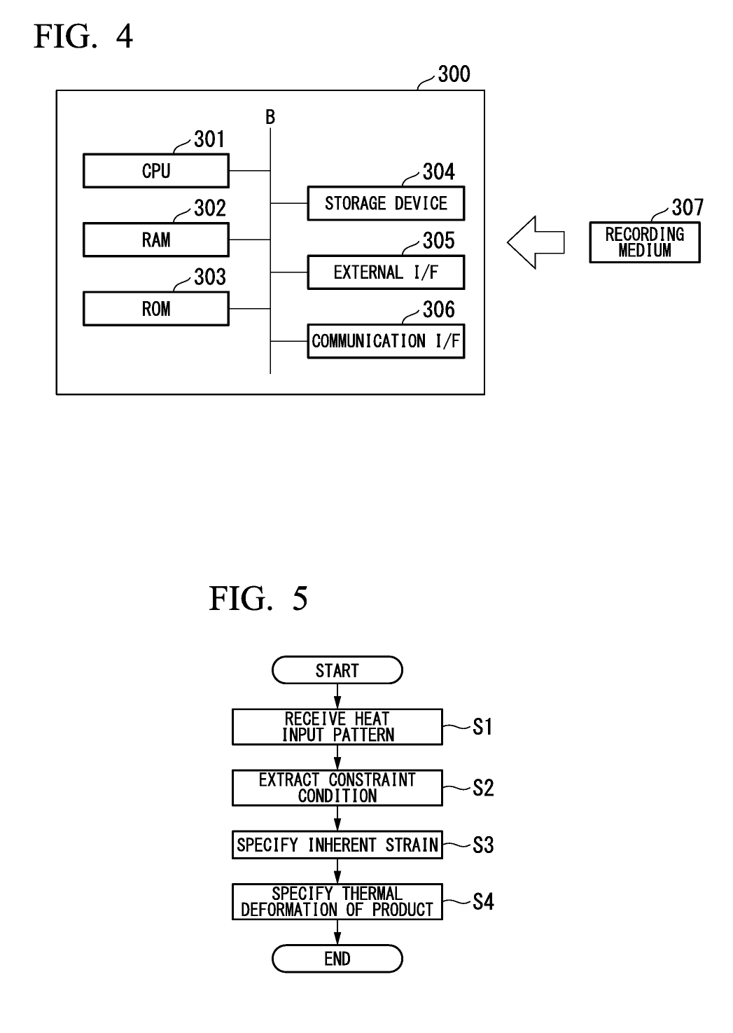

FIG. 4 is a block diagram showing a configuration of an information processing device that realizes the three-dimensional lamination thermal deformation amount calculation device 100 according to the first embodiment of the present invention. The three-dimensional lamination thermal deformation amount calculation device 100 is realized by using a general computer 300 shown in FIG. 4 which is an information processing device, for example. The computer 300 includes a central processing unit (CPU) 301, a random access memory (RAM) 302, a read only memory (ROM) 303, a storage device 304, an external interface (I/F) 305, and a communication I/F 306.

The CPU 301 is a calculation device that realizes various functions of the computer 300 by causing a program or data stored in a ROM 303, the storage device 304, or the like to be stored in a RAM 302 and executing a process. The RAM 302 is a volatile memory that is used as, for example, a work region of the CPU 301. The ROM 303 is a nonvolatile memory that stores the program or data even when power is turned off. The storage device 304 is realized by, for example, a hard disk drive (HDD), a solid state drive (SSD), or the like, and stores an operation system (OS), an application program, various pieces of data, and the like.

Each of the heat input pattern reception unit 101, the constraint condition extraction unit 102, the inherent strain determination unit 103, and the thermal deformation amount determination unit 104 in the three-dimensional lamination thermal deformation amount calculation device 100 is realized by, for example, the CPU 301 executing a control program stored in the storage device 304.

An external I/F 305 is an interface with an external device. An example of the external device includes a recording medium 307. The computer 300 can perform reading from and writing to the recording medium 307 via the external I/F 305. Examples of the recording medium 307 include an optical disc, a magnetic disk, a memory card, a Universal Serial Bus (USB) memory, and the like.

The communication I/F 306 is an interface that connects the computer 300 to the network through wired communication or wireless communication. A bus B is connected to each of the constituent devices described above, and various control signals and the like transmits to and receives from a control device.

Next, the process of the three-dimensional lamination thermal deformation amount calculation device 100 according to the first embodiment of the present invention will be described.

A process flow of the three-dimensional lamination thermal deformation amount calculation device 100 according to the first embodiment of the present invention shown in FIG. 5 will be described herein.

It should be noted that, in the first embodiment of the present invention, the distance from the surface of the product to each region indicated by the heat input pattern (the distance from the surface of the product to the heat input portion) is the constraint condition. A correspondence relationship between the constraint condition and the inherent strain corresponding to the constraint condition is obtained through an experiment, a simulation, or the like in advance, and is recorded in a data table TBL1 of a storage unit (for example, the storage device 304).

The heat input pattern reception unit 101 receives a heat input pattern configured of a plurality of heat input portions in one of the layers laminated by the three-dimensional lamination device (step S1).

The heat input pattern reception unit 101 transmits the received heat input pattern to the constraint condition extraction unit 102.

The constraint condition extraction unit 102 receives the heat input pattern from the heat input pattern reception unit 101.

The constraint condition extraction unit 102 extracts a constraint condition in each of the plurality of heat input portions on the basis of the received heat input pattern (step S2).

Specifically, the constraint condition extraction unit 102 specifies a distance from a surface of a product to each region indicated by the heat input pattern, that is, a distance from the surface of the product to each of the plurality of heat input portions.

The constraint condition extraction unit 102 transmits the extracted constraint condition (the distance from the surface of the product to each region indicated by the heat input pattern in the first embodiment of the present invention) to the inherent strain determination unit 103.

The inherent strain determination unit 103 receives the constraint condition from the constraint condition extraction unit 102.

When the inherent strain determination unit 103 receives the constraint condition, the inherent strain determination unit 103 reads the data table TBL1 indicating a correspondence relationship between the constraint condition and the inherent strain recorded in the storage unit.

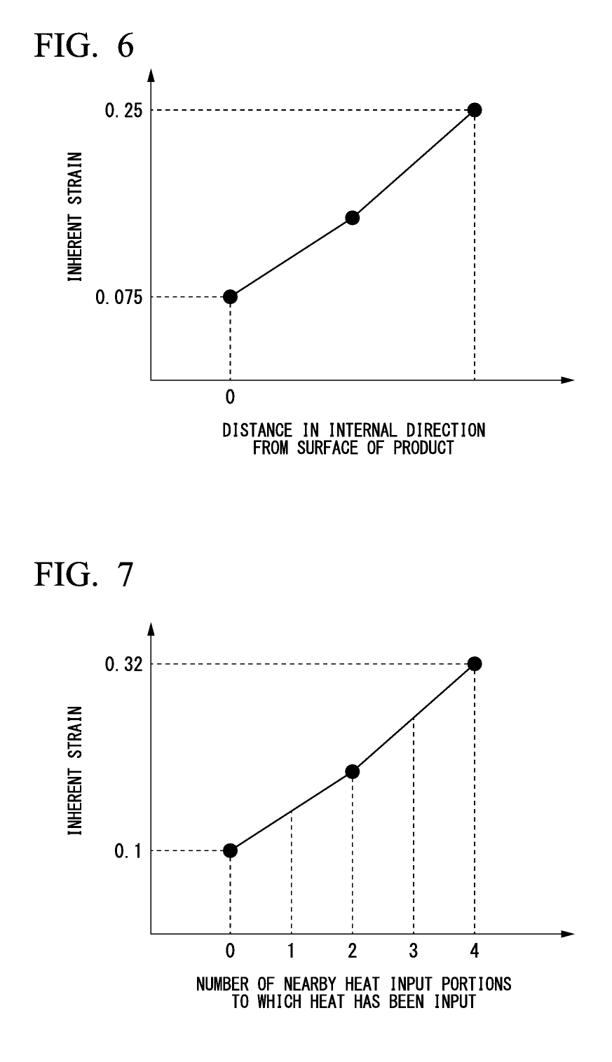

The data table TBL1 of the storage unit is, for example, a condition indicating a correspondence relationship between the distance from the surface of the product to each region indicated by the heat input pattern and the inherent strain corresponding to each of the distance to each region shown in FIG. 6.

The inherent strain determination unit 103 specifies an inherent strain in each of the plurality of heat input portions on the basis of the specified constraint condition and the read correspondence relationship between the constraint condition and the inherent strain (step S3).

Specifically, the inherent strain determination unit 103 specifies a constraint condition matching the received constraint condition in the read correspondence relationship between the constraint condition and the inherent strain. More specifically, the inherent strain determination unit 103 specifies a distance matching the distance from the surface of the product to each region indicated by the heat input pattern, which is the received constraint condition, in the read correspondence relationship between the constraint condition and the inherent strain. The inherent strain determination unit 103 specifies an inherent strain corresponding to the specified distance in the read correspondence relationship between the constraint condition and the inherent strain.

The inherent strain determination unit 103 transmits the specified inherent strain to the thermal deformation amount determination unit 104.

The thermal deformation amount determination unit 104 receives the inherent strain from the inherent strain determination unit 103.

The thermal deformation amount determination unit 104 specifies a thermal deformation of the product on the basis of the received inherent strain in each of the plurality of heat input portions (step S4).

Specifically, the thermal deformation amount determination unit 104 applies the received inherent strain to each of the plurality of heat input portions, and calculates the thermal deformation of the product using a distortion indicated by the applied inherent strain as a correction value.

The three-dimensional lamination thermal deformation amount calculation device 100 according to the first embodiment of the present invention has been described above. The three-dimensional lamination thermal deformation amount calculation device 100 includes the heat input pattern reception unit 101, the constraint condition extraction unit 102, the inherent strain determination unit 103, and the thermal deformation amount determination unit 104. The heat input pattern reception unit 101 receives the heat input pattern configured of a plurality of heat input portions in one of the layers laminated by the three-dimensional lamination device. The constraint condition extraction unit 102 extracts the constraint condition in each of the plurality of heat input portions on the basis of the heat input pattern received by the heat input pattern reception unit 101. The inherent strain determination unit 103 obtains the inherent strain in each of the plurality of heat input portions on the basis of the constraint condition extracted by the constraint condition extraction unit 102. The thermal deformation amount determination unit 104 obtains the thermal deformation of the product on the basis of the inherent strain in each of the plurality of heat input portions obtained by the inherent strain determination unit 103.

Thus, the three-dimensional lamination thermal deformation amount calculation device 100, for example, can accurately evaluate a thermal deformation amount of a laminated structure including a support portion in a short time.

### Second Embodiment

A configuration of a three-dimensional lamination system including a three-dimensional lamination thermal deformation amount calculation device according to a second embodiment of the present invention will be described.

The three-dimensional lamination system 1 includes a data creation device 10, a network 20, and a three-dimensional lamination device 30, similar to the three-dimensional lamination thermal deformation amount calculation device 100 according to the first embodiment of the present invention.

The three-dimensional lamination thermal deformation amount calculation device 100 includes a heat input pattern reception unit 101, a constraint condition extraction unit 102, an inherent strain determination unit 103, and a thermal deformation amount determination unit 104.

Next, a process of the three-dimensional lamination thermal deformation amount calculation device 100 according to the second embodiment of the present invention will be described.

A process flow of the three-dimensional lamination thermal deformation amount calculation device 100 according to the second embodiment of the present invention that is the same as the process flow of the three-dimensional lamination thermal deformation amount calculation device 100 according to the first embodiment of the present invention shown in FIG. 5 will be described herein.

It should be noted that in the second embodiment of the present invention, the constraint condition is the number of nearby heat input portions to which heat have been input when heat is input to a heat input portion. The correspondence relationship between the constraint condition and the inherent strain corresponding to the constraint condition is obtained through experiment, simulation, or the like in advance, and is recorded in a data table TBL2 of a storage unit (for example, the storage device 304).

The heat input pattern reception unit 101 receives a heat input pattern configured of a plurality of heat input portions in one of layers laminated by the three-dimensional lamination device (step S1).

The heat input pattern reception unit 101 transmits the received heat input pattern to the constraint condition extraction unit 102.

The constraint condition extraction unit 102 receives the heat input pattern from the heat input pattern reception unit 101.

The constraint condition extraction unit 102 extracts a constraint condition in each of the plurality of heat input portions on the basis of the received heat input pattern (step S2).

Specifically, the constraint condition extraction unit 102 specifies the number of nearby heat input portions to which heat have been input when heat is input to the heat input portion.

More specifically, for example, when the order of inputting the heat to the heat input portions is determined in advance, the constraint condition extraction unit 102 can specify the number of nearby heat input portions to which heat have been input immediately before the heat is input to the heat input portion. Further, for example, when a random number can be acquired in a case in which the order of inputting the heat to the heat input portions is randomly determined using the random number or the like, the constraint condition extraction unit 102 may specify the number of nearby heat input portions to which heat has been input immediately before the heat is input to each heat input portion, similar to a case in which the order of inputting heat to the heat input portions is determined in advance. Further, although the constraint condition extraction unit 102 cannot acquire the random number, since there is no nearby heat input portion to which the heat has been input for the regions 1 to 16, for example, in the case of the 8×8 regions shown in the parts (a) to (d) of FIG. 3, the number 0 of nearby heat input portions to which heat have been input is allocated to all of the regions 1 to 16 in advance, regardless of a heat input order. Further, for regions 17 to 32, since there is no nearby heat input portion to which the heat has been input, the number 0 of nearby heat input portions to which heat have been input may be allocated to all of the regions 17 to 32 in advance, regardless of a heat input order. Further, for regions 33 to 48, the number of nearby heat input portions to which the heat has been input for the region 36 is 2, the number of nearby heat input portions to which heat have been input for the regions 33, 34, 35, 40, 44, and 48 is 3, and the number of nearby heat input portions to which heat have been input for the regions 37, 38, 39, 41, 42, 43, 45, 46, and 47 is 4. Therefore, for example, the number 4 of nearby heat input portions to which heat have been input, in which the number of regions is largest, among the numbers 2 to 4 of nearby heat input portions to which heat have been input may be allocated to all of the regions 33 to 48 in advance, regardless of a heat input order. Further, for regions 49 to 64, the number of nearby heat input portions to which the heat has been input for the region 61 is 2, the number of nearby heat input portions to which heat have been input for the regions 49, 53, 57, 62, 63, and 64 is 3, and the number of nearby heat input portions to which heat have been input for the regions 50, 51, 52, 54, 55, 56, 58, 59, and 60 is 4. Therefore, for example, the number 4 of nearby heat input portions to which heat have been input, in which the number of regions is largest, among the numbers 2 to 4 of nearby heat input portions to which heat have been input may be allocated to all of the regions 49 to 64 in advance, regardless of a heat input order. Thus, the number of nearby heat input portions to which heat have been input may be allocated in advance. Further, the number of nearby heat input portions to which heat have been input, in which the number of regions is largest, among the numbers of nearby heat input portions to which heat have been input may be allocated to all of the regions that are targets, as in the above example. Further, the average value of the number of nearby heat input portions to which heat have been input with all regions that are targets may be rounded to an integer and allocated to all the regions.

The constraint condition extraction unit 102 transmits the extracted constraint condition (the number of nearby heat input portions to which heat have been input when heat is input to the heat input portion in the second embodiment of the present invention) to the inherent strain determination unit 103.

The inherent strain determination unit 103 receives the constraint condition from the constraint condition extraction unit 102.

When the inherent strain determination unit 103 receives the constraint condition, the inherent strain determination unit 103 reads the data table TBL2 indicating a correspondence relationship between the constraint condition and the inherent strain recorded in the storage unit.

The data table TBL2 of the storage unit is, for example, a condition indicating a correspondence relationship between the number of nearby heat input portions to which heat have been input when the heat is input to the heat input portion and the inherent strain corresponding to each of the nearby heat input portions shown in FIG. 7.

The inherent strain determination unit 103 specifies an inherent strain in each of the plurality of heat input portions on the basis of the specified constraint condition and the read correspondence relationship between the constraint condition and the inherent strain (step S3).

Specifically, the inherent strain determination unit 103 specifies a constraint condition matching the received constraint condition in the read correspondence relationship between the constraint condition and the inherent strain. More specifically, the inherent strain determination unit 103 specifies the number of nearby heat input portions matching the number of nearby heat input portions to which heat have been input when heat is input to the heat input portion, which is the received constraint condition, in the read correspondence relationship between the constraint condition and the inherent strain. The inherent strain determination unit 103 specifies an inherent strain corresponding to the specified number of heat input portions in the read correspondence relationship between the constraint condition and the inherent strain.

The inherent strain determination unit 103 transmits the specified inherent strain to the thermal deformation amount determination unit 104.

The thermal deformation amount determination unit 104 receives the inherent strain from the inherent strain determination unit 103.

The thermal deformation amount determination unit 104 specifies a thermal deformation of the product on the basis of the received inherent strain in each of the plurality of heat input portions (step S4).

Specifically, the thermal deformation amount determination unit 104 applies the received inherent strain to each of the plurality of heat input portions, and calculates the thermal deformation of the product using a distortion indicated by the applied inherent strain as a correction value.

It should be noted that the constraint condition in the second embodiment of the present invention is not limited to the number of nearby heat input portions to which heat have been input when heat is input to the heat input portion. The constraint condition in the second embodiment of the present invention may be, for example, at least one of the number, an area, and a length of the nearby heat input portions to which heat have been input when heat is input to the heat input portion.

The three-dimensional lamination thermal deformation amount calculation device 100 according to the second embodiment of the present invention has been described above. The three-dimensional lamination thermal deformation amount calculation device 100 includes the heat input pattern reception unit 101, the constraint condition extraction unit 102, the inherent strain determination unit 103, and the thermal deformation amount determination unit 104. The heat input pattern reception unit 101 receives the heat input pattern configured of the plurality of heat input portions in the one of layers laminated by the three-dimensional lamination device. The constraint condition extraction unit 102 extracts the constraint condition in each of the plurality of heat input portions on the basis of the heat input pattern received by the heat input pattern reception unit 101. The inherent strain determination unit 103 obtains the inherent strain in each of the plurality of heat input portions on the basis of the constraint condition extracted by the constraint condition extraction unit 102. The thermal deformation amount determination unit 104 obtains the thermal deformation of the product on the basis of the inherent strain in each of the plurality of heat input portions obtained by the inherent strain determination unit 103.

Thus, the three-dimensional lamination thermal deformation amount calculation device 100, for example, can accurately evaluate a thermal deformation amount of a laminated structure such as a support portion in a short time.

### Third Embodiment

A configuration of a three-dimensional lamination system including a three-dimensional lamination thermal deformation amount calculation device according to a third embodiment of the present invention will be described.

The three-dimensional lamination system 1 includes a data creation device 10, a network 20, and a three-dimensional lamination device 30, similar to the three-dimensional lamination thermal deformation amount calculation device 100 according to the first embodiment of the present invention.

The three-dimensional lamination thermal deformation amount calculation device 100 includes a heat input pattern reception unit 101, a constraint condition extraction unit 102, an inherent strain determination unit 103, and a thermal deformation amount determination unit 104.

Next, a process of the three-dimensional lamination thermal deformation amount calculation device 100 according to the third embodiment of the present invention will be described.

A process flow of the three-dimensional lamination thermal deformation amount calculation device 100 according to the third embodiment of the present invention that is the same as the process flow of the three-dimensional lamination thermal deformation amount calculation device 100 according to the first embodiment of the present invention shown in FIG. 5 will be described herein. It should be noted that in the third embodiment of the present invention, a combination of the distance from the surface of the product to each region indicated by the heat input pattern and the number of nearby heat input portions to which the heat has been input when the heat is input to the heat input portion is a constraint condition. The correspondence relationship between the constraint condition and the inherent strain corresponding to the constraint condition is obtained through experiment, simulation, or the like in advance, and is recorded in a data table TBL3 of a storage unit (for example, the storage device 304).

The heat input pattern reception unit 101 receives a heat input pattern configured of a plurality of heat input portions in one of layers laminated by the three-dimensional lamination device (step S1).

The heat input pattern reception unit 101 transmits the received heat input pattern to the constraint condition extraction unit 102.

The constraint condition extraction unit 102 receives the heat input pattern from the heat input pattern reception unit 101.

The constraint condition extraction unit 102 extracts a constraint condition in each of the plurality of heat input portions on the basis of the received heat input pattern (step S2).

Specifically, the constraint condition extraction unit 102 specifies the combination of the distance from the surface of the product to each region indicated by the heat input pattern and the number of nearby heat input portions to which the heat has been input when the heat is input to the heat input portion.

The constraint condition extraction unit 102 transmits the extracted constraint condition (the combination of the distance from the surface of the product to each region indicated by the heat input pattern and the number of nearby heat input portions to which the heat has been input when the heat is input to the heat input portion in the third embodiment of the present invention) to the inherent strain determination unit 103.

The inherent strain determination unit 103 receives the constraint condition from the constraint condition extraction unit 102.

When the inherent strain determination unit 103 receives the constraint condition, the inherent strain determination unit 103 reads the data table TBL3 indicating a correspondence relationship between the constraint condition and the inherent strain recorded in the storage unit.

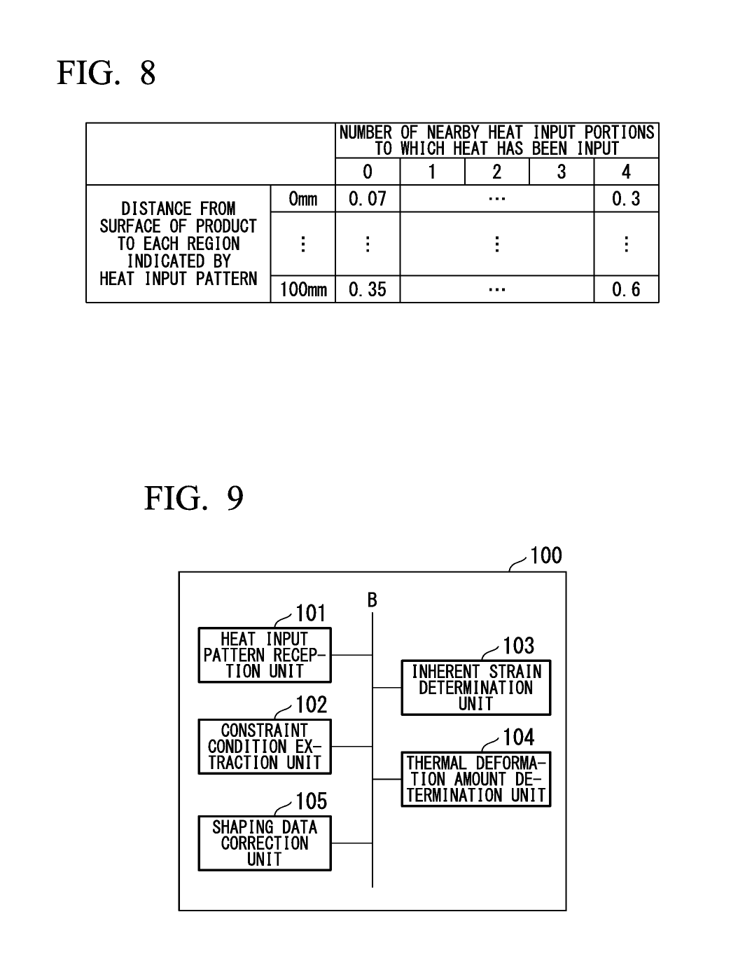

The data table TBL3 of the storage unit is, for example, a condition indicating a correspondence relationship between the combination of the distance from the surface of the product to each region indicated by the heat input pattern and the number of nearby heat input portions to which the heat has been input when the heat is input to the heat input portion, and the inherent strain corresponding to each of the combinations shown in FIG. 8.

The inherent strain determination unit 103 specifies an inherent strain in each of the plurality of heat input portions on the basis of the specified constraint condition and the read correspondence relationship between the constraint condition and the inherent strain corresponding to the constraint condition (step S3).

Specifically, the inherent strain determination unit 103 specifies a constraint condition matching the received constraint condition in the read correspondence relationship between the constraint condition and the inherent strain corresponding to the constraint condition. More specifically, the inherent strain determination unit 103 specifies a combination matching the combination of the distance from the surface of the product to each region indicated by the heat input pattern and the number of nearby heat input portions to which the heat has been input when the heat is input to the heat input portion, which is the received constraint condition, in the read correspondence relationship between the constraint condition and the inherent strain corresponding to the constraint condition. The inherent strain determination unit 103 specifies an inherent strain corresponding to the specified combination in the read correspondence relationship between the constraint condition and the inherent strain corresponding to the constraint condition.

The inherent strain determination unit 103 transmits the specified inherent strain to the thermal deformation amount determination unit 104.

The thermal deformation amount determination unit 104 receives the inherent strain from the inherent strain determination unit 103.

The thermal deformation amount determination unit 104 specifies a thermal deformation of the product on the basis of the received inherent strain in each of the plurality of heat input portions (step S4).

Specifically, the thermal deformation amount determination unit 104 applies the received inherent strain to each of the plurality of heat input portions, and calculates the thermal deformation of the product using a distortion indicated by the applied inherent strain as a correction value.

It should be noted that the constraint condition in the third embodiment of the present invention is not limited to the combination of the distance from the surface of the product to each region indicated by the heat input pattern and the number of nearby heat input portions to which the heat has been input when the heat is input to the heat input portion. The constraint condition in the third embodiment of the present invention may be, for example, a combination of the distance from the surface of the product to each region indicated by the heat input pattern and an area of nearby heat input portions to which the heat has been input when the heat is input to the heat input portion. Further, the constraint condition in the third embodiment of the present invention may be, for example, a combination of the distance from the surface of the product to each region indicated by the heat input pattern and a length of nearby heat input portions to which the heat has been input when the heat is input to the heat input portion.

The three-dimensional lamination thermal deformation amount calculation device 100 according to the third embodiment of the present invention has been described above. The three-dimensional lamination thermal deformation amount calculation device 100 includes the heat input pattern reception unit 101, the constraint condition extraction unit 102, the inherent strain determination unit 103, and the thermal deformation amount determination unit 104. The heat input pattern reception unit 101 receives the heat input pattern configured of the plurality of heat input portions in the one of layers laminated by the three-dimensional lamination device. The constraint condition extraction unit 102 extracts the constraint condition in each of the plurality of heat input portions on the basis of the heat input pattern received by the heat input pattern reception unit 101. The inherent strain determination unit 103 obtains the inherent strain in each of the plurality of heat input portions on the basis of the constraint condition extracted by the constraint condition extraction unit 102. The thermal deformation amount determination unit 104 obtains the thermal deformation of the product on the basis of the inherent strain in each of the plurality of heat input portions obtained by the inherent strain determination unit 103.

Thus, the three-dimensional lamination thermal deformation amount calculation device 100, for example, can accurately evaluate a thermal deformation amount of a laminated structure such as a support portion in a short time.

### Fourth Embodiment

A configuration of a three-dimensional lamination system including a three-dimensional lamination thermal deformation amount calculation device according to a fourth embodiment of the present invention will be described.

A three-dimensional lamination system 1 according to the fourth embodiment of the present invention is a system that corrects shaping data in advance so that a laminated structure (that is, a product) after heat input becomes a desired laminated structure on the basis of a result of evaluation of a thermal deformation amount of the laminated structure. The three-dimensional lamination system 1 includes a data creation device 10, a network 20, and a three-dimensional lamination device 30, similar to the three-dimensional lamination system 1 according to the first embodiment of the present invention. However, the three-dimensional lamination thermal deformation amount calculation device 100 included in the data creation device 10 further includes a shaping data correction unit 105, in addition to the heat input pattern reception unit 101, the constraint condition extraction unit 102, the inherent strain determination unit 103, and the thermal deformation amount determination unit 104, as shown in FIG. 9.

The shaping data correction unit 105 corrects the shaping data in advance so that the laminated structure after heat input becomes a laminated structure having a desired shape on the basis of the amount of thermal deformation specified by the thermal deformation amount determination unit 104. Specifically, the shaping data correction unit 105 expands the shaping data in advance so that the laminated structure after heat input becomes the laminated structure having a desired shape on the basis of the amount of thermal deformation of the laminated structure after heat input specified by the thermal deformation amount determination unit 104.

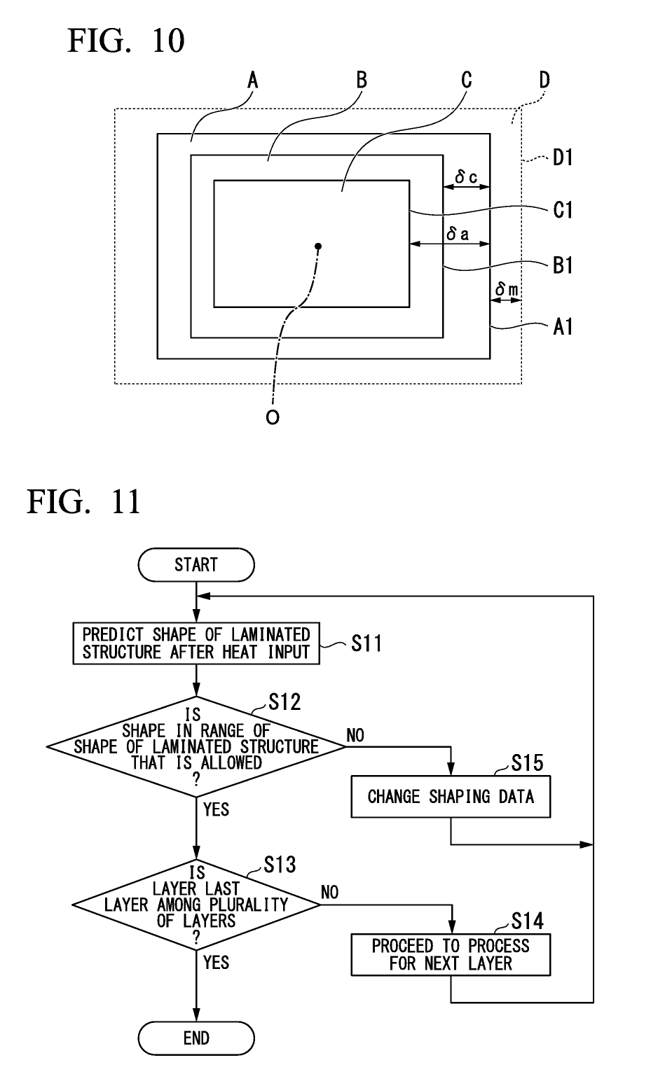

For example, in one of the plurality of layers that are laminated by the three-dimensional lamination device 30, it is assumed that the shaping data of the laminated structure is rectangle A, and the shape of the laminated structure allowed after heat input is rectangle B, as shown in FIG. 10. The shaping data correction unit 105, for example, predicts the shape of the laminated structure after heat input on the basis of an amount of shrinkage of the laminated structure due to heat specified by the thermal deformation amount determination unit 104 using a centroid O of the shaping data of the laminated structure before heat input as a reference of the shape, in a layer that is a target. The shape of the laminated structure after heat input predicted for the layer that is a target by the shaping data correction unit 105 is assumed to be a rectangle C. Here, a position B1 of a right side of the rectangle B is allowed by Sc toward the centroid O relative to a position A1 of a right side of the rectangle A, as shown in FIG. 10. Further, the shaping data correction unit 105 predicts that a position C1 of a right side of the rectangle C shrinks by δa toward the centroid O relative to the position A1 of the right side of the rectangle A, as shown in FIG. 10. In this case, the shaping data correction unit 105 changes the position A1 of the right side of the rectangle A into a position D1 of a right side of a rectangle D obtained by moving the position A1 of the right side of the rectangle A by δm (=α(δa−δc)) to right from the centroid O to thereby change the shape of rectangle A, as shown in FIG. 10. Here, α is a coefficient and is determined by, for example, a shaped shape or accuracy of dimensions. In addition, the shaping data correction unit 105 changes positions of upper, left, and lower sides of the rectangle A similar to the position A1 of the right side to thereby change the shape of the rectangle A.

Next, a process of the three-dimensional lamination thermal deformation amount calculation device 100 according to the fourth embodiment of the present invention will be described.

A process flow of the three-dimensional lamination thermal deformation amount calculation device 100 according to the fourth embodiment of the present invention shown in FIG. 11, in which it is assumed that the three-dimensional lamination thermal deformation amount calculation device 100 performs the processes of steps S1 to S4 shown in FIG. 5 to specify thermal deformation of the product, will be described herein.

The shaping data correction unit 105 corrects the shaping data in advance so that the laminated structure after heat input becomes a desired laminated structure on the basis of the amount of thermal deformation specified by the thermal deformation amount determination unit 104.

After the processes of steps S1 to S4, the shaping data correction unit 105 predicts the shape of the laminated structure after heat input on the basis of an amount of shrinkage of the laminated structure due to heat specified by the thermal deformation amount determination unit 104 using the centroid O of the shaping data of the laminated structure before heat input as a reference of the shape, in the layer that is a target (step S11). For example, in a first layer among the plurality of layers that are laminated by the three-dimensional lamination device 30, it is assumed that the shaping data of the laminated structure is rectangle A, and the shape of the laminated structure allowed after heat input is rectangle B, as shown in FIG. 10. Further, it is assumed that the position of the right side of the rectangle B is allowed by δc toward the centroid O relative to the right side of the rectangle A, as shown in FIG. 10. The shaping data correction unit 105 predicts the shape of the laminated structure after heat input to be the rectangle C shown in FIG. 10 on the basis of the amount of shrinkage of the laminated structure due to heat specified by the thermal deformation amount determination unit 104 using the centroid O of the shaping data of the laminated structure before heat input as a reference of the shape, in the layer that is a target. That is, the shaping data correction unit 105 predicts that a position of the right side of the rectangle C shrinks by δa toward the centroid O relative to the right side of the rectangle A, as shown in FIG. 10.

The shaping data correction unit 105 determines whether the predicted shape of the laminated structure after heat input is in a range of the shape of the laminated structure allowed after the heat input (step S12).

When the shaping data correction unit 105 determines that the predicted shape of the laminated structure after heat input is in the range of the shape of the laminated structure allowed after heat input (YES in step S12), the shaping data correction unit 105 determines whether or not a layer that is a target is the last one of the plurality of layers that are laminated by the three-dimensional lamination device 30 (step S13).

When the shaping data correction unit 105 determines that the layer that is a target is not the last one of the plurality of layers that are laminated by the three-dimensional lamination device 30 (NO in step S13), the shaping data correction unit 105 proceeds to a process for the next layer that is laminated by the three-dimensional lamination device 30 (step S14), and returns to the process of step S11.

Further, when the shaping data correction unit 105 determines that the layer that is a target is the last layer among the plurality of layers laminated by the three-dimensional lamination device 30 (YES in step S13), the shaping data correction unit 105 ends the process.

Further, when the shaping data correction unit 105 determines that the predicted shape of the laminated structure after heat input is out of a range of the shape of the laminated structure allowed after heat input (NO in step S12), the shaping data correction unit 105 changes the shaping data so that the laminated structure after heat input becomes a desired laminated structure on the basis of the amount of heat deformation of the laminated structure after heat input specified by the thermal deformation amount determination unit 104 (step S15). For example, when the shaping data correction unit 105 determines that the predicted shape of the laminated structure after heat input is out of the range of the shape of the laminated structure allowed after heat input, the shaping data correction unit 105 changes, for example, the shaping data of the heat input portion so that the laminated structure after heat input becomes a desired laminated structure on the basis of the amount of heat deformation of the laminated structure after heat input specified by the thermal deformation amount determination unit 104, to thereby change all the shaping data to a rectangle D. The shaping data correction unit 105 returns to the process of step S11. It should be noted that, in step S11 after the shaping data has been changed, the shaping data correction unit 105 divides a region indicated by the shaping data into intersections on a Go board that have the same size (for example, 5 mm square) as that before the shaping data is changed, and performs a process.

The three-dimensional lamination thermal deformation amount calculation device 100 according to the fourth embodiment of the present invention has been described above. The three-dimensional lamination thermal deformation amount calculation device 100 includes the heat input pattern reception unit 101, the constraint condition extraction unit 102, the inherent strain determination unit 103, the thermal deformation amount determination unit 104, and the shaping data correction unit 105.

The shaping data correction unit 105 corrects the shaping data in advance so that the laminated structure after heat input becomes a laminated structure having a desired shape on the basis of the amount of thermal deformation specified by the thermal deformation amount determination unit 104.

Thus, the three-dimensional lamination thermal deformation amount calculation device 100 can perform preparation so that the laminated structure after heat input becomes the laminated structure having a desired shape, and reduce a defective rate of products. As a result, it is possible to efficiently manufacture products in a short time at low cost.

It should be noted that the three-dimensional lamination thermal deformation amount calculation device 100 in each embodiment of the present invention is also referred to as a thermal deformation amount calculation device.

It should be noted that, in the fourth embodiment of the present invention, the shaping data correction unit 105 may expand the shaping data in advance, in a direction toward each of heat input portions forming an outer shape of the laminated structure in minimum units by which the heat input can be controlled from the centroid O of the shaping data of the laminated structure before heat input, so that the laminated structure after heat input becomes a desired laminated structure on the basis of the amount of thermal deformation of the laminated structure after heat input specified by the thermal deformation amount determination unit 104. Further, the shaping data correction unit 105 may represent the outer shape of the laminated structure using polar coordinates with the centroid O of the shaping data of the laminated structure before heat input as an origin and expand the shaping data corresponding to each predetermined angle (for example, one degree) in a normal direction of the outer shape of the laminated structure, so that the laminated structure after heat input becomes a desired laminated structure on the basis of the amount of thermal deformation of the laminated structure after heat input specified by the thermal deformation amount determination unit 104. For example, the shaping data correction unit 105 may represent the outer shape of the laminated structure using polar coordinates with the centroid O of the shaping data of the laminated structure before heat input as an origin and expand the shaping data of the heat input portions corresponding to each predetermined angle in a normal direction of the outer shape of the laminated structure to thereby change all the shaping data so that the laminated structure after heat input becomes a desired laminated structure on the basis of the amount of thermal deformation of the laminated structure after heat input specified by the thermal deformation amount determination unit 104.

It should be noted that, in the fourth embodiment of the present invention, the constraint condition extracted by the constraint condition extraction unit 102 is the distance from the surface of the product to each region indicated by the heat input pattern, and the number of nearby heat input portions to which the heat has been input when the heat is input to the heat input portion. In addition, the constraint condition may be at least one of the number, an area, and a length of nearby heat input portions to which the heat has been input when the heat is input to the heat input portion, or may be a combination of the distance from the surface of the product to each region indicated by the heat input pattern and the number of nearby heat input portions to which the heat has been input when the heat is input to the heat input portion.

It should be noted that an example in which the laminated structure after heat input shrinks and the three-dimensional lamination thermal deformation amount calculation device 100 performs a change to expand the region indicated by the shaping data has been described in the fourth embodiment of the present invention. However, in another embodiment of the present invention, the laminated structure after heat input may be expanded and the three-dimensional lamination thermal deformation amount calculation device 100 may perform a change to reduce the region indicated by the shaping data.

It should be noted that in the three-dimensional lamination thermal deformation amount calculation device 100 according to the first to fourth embodiments of the present invention, the constraint condition may include a distribution of heat of nearby heat input portions to which heat has been input when heat is input to the heat input portion. The heat input pattern reception unit 101, the constraint condition extraction unit 102, the inherent strain determination unit 103, and the thermal deformation amount determination unit 104 of the three-dimensional lamination thermal deformation amount calculation device 100 may further apply a constraint condition of the heat distribution to obtain thermal deformation of a product.

It should be noted that the three-dimensional lamination thermal deformation amount calculation device 100 according to the first to fourth embodiments of the present invention may interpolate desired data, for example, through linear interpolation and perform the process using the interpolated data when each piece of data that is used for the process is a discrete value and there is no desired value.

It should be noted that an order of the processes according to the embodiment of the present invention may be changed in a range in which an appropriate process is performed.

Each of the storage units may be included anywhere in a range in which appropriate information transmission and reception are performed. In addition, each of the storage units may store a plurality of pieces of data present in the range in which the appropriate information transmission and reception are performed in a distributive manner.

Although the embodiments of the present invention have been described, each of the devices of the three-dimensional lamination thermal deformation amount calculation device 100 and the three-dimensional lamination system 1 described above may include a computer system therein. The steps of the process described above are stored in the form of a program in a computer-readable recording medium, and a computer reads and executes this program so that the above process is performed. Here, the computer-readable recording medium refers to a magnetic disk, a magneto-optical disk, a CD-ROM, a DVD-ROM, a semiconductor memory, or the like. Further, a computer program may be distributed to a computer via a communication line, and the computer receiving the distribution may execute the program.

Further, the above program may realize some of the above-described functions. Further, the above-described program may be a file capable of realizing the above-described functions in combination with a program previously recorded in a computer system, that is, a differential file (a differential program).

Several embodiments of the present invention have been described, but these embodiments are examples and do not limit the scope of the invention. Various additions, omissions, substitutions, and changes may be made to these embodiments without departing from the gist of the invention.

### INDUSTRIAL APPLICABILITY

With the three-dimensional lamination thermal deformation amount calculation device according to the embodiments of the present invention, it is possible to accurately evaluate the thermal deformation amount of the laminated structure in a short time.

### REFERENCE SIGNS LIST

10 Data creation device

20 Network

30 Three-dimensional lamination device

100 Three-dimensional lamination thermal deformation amount calculation device

101 Heat input pattern reception unit

102 Constraint condition extraction unit

103 Inherent strain determination unit

104 Thermal deformation amount determination unit

105 Shaping data correction unit

300 Computer

301 CPU

302 RAM

303 ROM

304 Storage device

305 External I/F

306 Communication 1/F

307 Recording medium

1. A thermal deformation amount calculation device for analyzing thermal deformation occurring in a product when the product is manufactured by sequentially laminating materials and performing heat input using a three-dimensional lamination device,
wherein one layer is configured of a plurality of heat input portions which are units in which input heat is received from the three-dimensional lamination device, and
the thermal deformation amount calculation device comprises:
a heat input pattern reception unit that is configured to receive a heat input pattern that is an order in which the plurality of heat input portions receive the input heat;
a constraint condition extraction unit that is configured to extract a constraint condition in each of the plurality of heat input portions on the basis of the heat input pattern;
an inherent strain determination unit that is configured to obtain an inherent strain in each of the plurality of heat input portions on the basis of the constraint condition; and
a thermal deformation amount determination unit that is configured to obtain thermal deformation of the product on the basis of the inherent strain in each of the plurality of heat input portions.

2. The thermal deformation amount calculation device according to claim 1, wherein the constraint condition includes a parameter regarding a distance from a surface.

3. The thermal deformation amount calculation device according to claim 1, wherein the constraint condition includes at least one of a number, an area, and a length of nearby heat input portions to which heat has been input when heat is input to the heat input portion.

4. The thermal deformation amount calculation device according to claim 1, wherein the constraint condition includes a distribution of heat of nearby heat input portions to which heat has been input when heat is input to the heat input portion.

5. The thermal deformation amount calculation device according to claim 1, further comprising a shaping data correction unit that is configured to change data for shaping the product on the basis of the thermal deformation of the product obtained by the thermal deformation amount determination unit.

6. The thermal deformation amount calculation device according to claim 5, wherein the shaping data correction unit is configured to predict a change in shape due to thermal shrinkage of the product and determine whether or not a change in the shaping data is necessary on the basis of the predicted shape of the product and an allowable range of the change in shape due to thermal shrinkage of the product.

7. The thermal deformation amount calculation device according to claim 6, wherein the shaping data correction unit is configured to change the shaping data so that the predicted shape of the product is in the allowable range when it is determined that the predicted shape of the product is out of the allowable range.

8. The thermal deformation amount calculation device according to claim 6, wherein the shaping data correction unit is configured to determine whether or not correction of the shaping data is necessary for each of the layers on which the material is laminated.

9. The thermal deformation amount calculation device according to claim 5, wherein the shaping data correction unit is configured to change the shaping data with respect to the heat input portions that are minimum units in which heat input is controllable.

10. The thermal deformation amount calculation device according to claim 9, wherein at least one of the plurality of heat input portions forms an outer shape of the product.

11. A three-dimensional lamination system comprising:
the thermal deformation amount calculation device according to claim 1; and
a three-dimensional lamination device that is configured to shape a product having a three-dimensional shape using shaping data for shaping the product having a three-dimensional shape generated on the basis of a calculation result of the thermal deformation amount calculation device.

12. A three-dimensional lamination method of analyzing thermal deformation occurring in a product when the product is manufactured by sequentially laminating materials and performing heat input using a three-dimensional lamination device, the three-dimensional lamination method comprising:
receiving a heat input pattern that is an order in which the plurality of heat input portions receive the input heat in one layer configured of a plurality of heat input portions which are units in which input heat is received from the three-dimensional lamination device;
extracting a constraint condition in each of the plurality of heat input portions on the basis of the heat input pattern;
obtaining an inherent strain in each of the plurality of heat input portions on the basis of the constraint condition; and
obtaining thermal deformation of the product on the basis of the inherent strain in each of the plurality of heat input portions.

13. A non-transitory computer readable medium containing program instruction for causing a computer to execute a method of analyzing thermal deformation occurring in a product when the product is manufactured by sequentially laminating materials and performing heat input using a three-dimensional lamination device, the non-transitory computer readable medium containing program instruction causing the computer to execute:
receiving a heat input pattern that is an order in which the plurality of heat input portions receive the input heat in one layer configured of a plurality of heat input portions which are units in which input heat is received from the three-dimensional lamination device;
extracting a constraint condition in each of the plurality of heat input portions on the basis of the heat input pattern;
obtaining an inherent strain in each of the plurality of heat input portions on the basis of the constraint condition; and
obtaining thermal deformation of the product on the basis of the inherent strain in each of the plurality of heat input portions.
